(19) United States
(12) Patent Application Publication
(10) Pub. No.: US 2004/0028780 A1
(43) Pub. Date: Feb. 12, 2004

(54) Removable edible label based on collagen for labelling food products

(76) Inventors: Franz Maser, Weinheim (DE); Oliver Tuerk, Weinheim (DE)

Correspondence Address: KATTEN MUCHIN ZAVIS ROSENMAN, 575 MADISON AVENUE, NEW YORK, NY, 10022-2585, US

(21) Appl. No.: 10/613,130

(22) Filed: Jul. 2, 2003

Related U.S. Application Data
(63) Continuation of application No. PCT/IB01/00138, filed on Jan. 9, 2001.

(51) Int. Cl. A21D 13/00

(52) U.S. Cl. 426/138

(57) ABSTRACT

Removable edible label based on collagen for labelling food products, the label being free of any adhesive layer, being able to stick to the food product throughout the slaughter process until packaging and being able to be removed intact from the food product whenever desired, said label has a swelling rate in water between 120% and 450% and a pH value between 5,5 and 10,0. The present invention relates to removable edible labels based on collagen for labelling food products, to edible films based on collagen, to a process for preparing an edible film based on collagen from a collagen gel and to a process for preparing removable edible labels based on collagen from edible films.

This application is a continuation of PCT/IB01/00138, filed Jan. 9, 2001, still pending.

This invention relates to the field of labelling food products. Namely, the present invention relates to removable edible labels based on collagen for labelling food products, to edible films based on collagen, to a process for preparing an edible film based on collagen from a collagen gel and to a process for preparing removable edible labels based on collagen from edible films.

Definitions:

Collagen casings: Semi-synthetic sausage casings, generally (but not necessarily or exclusively) based on bovine hide collagen.

Collagen films: Semi-synthetic films, generally (but not necessarily or exclusively) based on bovine hide collagen.

Collagen gel: Pasty suspension of acid-swollen collagen fibres and fibrils, generally prepared from bovine hide or other suitable sources of fibrillar collagen. The preparation of such collagen gels may follow different technologies known in the art. The detailed composition of collagen gels can be very complex as other substances like non-collagenous proteins, cellulose, hydrocolloids, plasticizers, crosslinkers, dyes and the like may be added in various amounts to the collagen suspension. Also, the degree of degradation of the collagen may vary within a wide range, depending on the raw material treatment which, in turn, depends on the properties of the final product aimed at. The degree of degradation of the collagen may be expressed, for example, in terms of amide nitrogen content, distribution of fibre dimensions, the fraction of extractable (“soluble”) collagen or collagen degradation products and the shrinkage temperature under defined conditions of the collagen fibre suspension.

Hydrothermal stability: Capability of a collagen casing to stand the cooking cycles applied in the course of the manufacture of cooked sausages like Wiener, Frankfurter, Bologna, etc. Hydrothermal stability could also required for an edible collagen label to stand the temperatures ocurring in a thermo transfer printer.

Swelling rate: One of numerous parameters suitable to describe the degree of crosslinking of products based on collagen. The swelling rate is calculated from the sample weight after soaking in water for 30 minutes and the weight of the dry sample. Thus, a swelling rate of 200% means that the sample under consideration is able to take up a quantity of water which corresponds to exactly twice its dry weight. The more highly crosslinked a sample is, the lower is the swelling rate found and vice versa.

Percentages: All percentages given are based on total weight unless otherwise specified.

Introduction:

Before the BSE (Bovine Spongiform Encephalopathy) crisis the question of traceability only had a limited priority in meat industry. However, in recent years this aspect has become vital.

Nowadays, consumers demand total transparency to have confidence in their meat and meat products. Even legal decisions take this fact into account. One of the most recent ones is the Regulation (EC) No 1760/2000 “establishing a system for the identification and registration of bovine animals and regarding the labelling of beef and beef products and repealing Council regulation (EC) No 820/97”, issued by the European Parliament and the Council in Jul. 2000. The goal of that regulation is to “maintain and strengthen the confidence of consumers in beef and to avoid misleading them”. Therefore, “it is necessary to develop the framework in which the information is made available to consumers by sufficient and clear labelling of product.”

Apart from consumer assurance and confidence, traceability is an essential tool for production control, food security and the prevention of risks.

### DESCRIPTION OF THE STATE OF THE ART

The current state of the art regarding the assurance of traceability of meat and meat products is illustrated by means of an example in which meat intended for sausage manufacture is accompanied from the animal to the final stuffing operation:

The chain of identification begins at the holdings where the animals are raised. The main methods for identification applied there are: ink jet marking, tattooing, use of ear tags and implantation of transponders. The discussion of limitations or advantages of the individual methods is beyond the scope of this application.

At the stage of the slaughterhouses and cutting halls, carcasses, halves, quarters and and cuts have to be identified by means of data carriers. The information available on such data carriers may be coded via bar codes or may consist of a text in clear.

In current practice, the carriers which bear the information are labels based on plastic, cardboard or paper. The labels are fixed to the carcasses/halves/quarters/cuts by means of metal or plastic clips. Neither the clips nor the currently used label materials are really suitable for use in food processing. Frequently, the clips and/or the labels remain undiscovered on halves/quarters and cuts during further processing. As a consequence machines are damaged, causing non productive times in the meat plants. Even worse, metal and plastic materials do not comply with food safety aspects, cardboard and paper labels do not comply with hygiene requirements.

At the stage of processing meat into sausages, meat emulsions are generally prepared in specific areas while the stuffing operation may be in some remote places. For logistical reasons, emulsions must generally be prepared in advance and stored in units of about 200 kg in mobile containers which, in turn, are stored in defined storage areas from where the emulsion containers can be removed to refill the stuffer whenever this is necessary. In general, various types of sausages are manufactured in parallel, all of them requiring different compositions. As a consequence, in the storage areas one can find emulsion containers with different emulsions at the same time. In order to avoid confusion, labels (made of plastic/cardbord/paper) are used to unambiguously identify the contents of each container. In futher processing, however, it occasionally happens that a label is not removed before filling the stuffer, and either the entire label or fragments of it appear in the final sausage as a foreign body.

What is needed to overcome the limitations outlined above is a label

which is able to fulfil the function of a carrier of traceability-related information (bar code or text in clear)

which does not represent a source of damage to machines,

which complies with all food safety and hygiene aspects,

which, in practice, performs very similar to the most frequently used paper labels, i.e. which can be used on standard printer equipment

which reliably sticks to a piece of meat and do so under all conditions normally found in meat processing (including storage in a cool store and during all common transport operations),

which, on the other hand, can be easily and completely removed from the product labelled,

which is available at a reasonable price.

There have been various attempts in the past to overcome the problems addressed. However, all of the labels suggested so far were unable to fulfil the requirements of an “ideal” label as listed above.

UK patent application GB 2 142 557 suggested the introduction of edible collagen labels, part or all of which are provided with an adhesive coating to ensure the adherence to the meat. In fact, such labels have been marketed in a limited quantity. They were presented on a release paper in the form of individual labels coated with a food-compatible adhesive. The adhesive coating was deemed to be crucial for the labels to properly stick to meat. However, coating the labels with an adhesive and presenting them as individual labels arranged on a release paper rendered the product too expensive to be accepted by a wider range of meat processors.

In ham manufacture very thin walled collagen labels (wall thickness <25 μm) are known to be used. However, the function of those labels is completely different, as they do not bear information related with the field of traceability (like bar codes or other production-related data). Those labels are related with advertisement and generally bear the logo of the manufacturer of the product. Those labels require, in a separate working step before sales, the application of letter print or flexo print technologies for printing; they would fail in standard printer equipment known from printing paper or cardboard labels. Therefore, such labels are not suitable to overcome the problems related with the use of non-edible labels. Moreover, such labels are generally not intended to be removed from the product. In contrast those labels frequently are considered as integral components of the final product.

WO 94/22315 discloses the finding that collagen labels may stick to the meat even without an adhesive if the collagen is acidic (pH of the label in the range between 2 and 5) and the degree of the crosslinking of the collagen is low enough as to allow a water uptake by the product of 500%-1500% (“swelling rate”=500%-1500%). The function of the label addressed in that application is mainly to serve as a transparent label, printed on the reverse side and, thus, being able to protect the printing from accidental damage or even to allow the transfer of ink from the label to the food surface. It is explicitly stated that such acid labels stick so well to the meat that they are “difficult to remove intact”. However, this property does not comply with the requirements in practice: in reality, the user intends to remove the label completely from the meat once it has fulfilled its function as a carrier of traceability-related information. This is of the reasons why in reality the labels disclosed in WO 94/22315 are not really accepted in the art and, as a consequence, are not widely spread in the market.

Another reason of this limited acceptance may be the fact that the transparency of the labels disclosed in WO 94/22315, originally thought to be an advantage over coloured labels, makes it more difficult to localise them on the meat. Therefore, missing the favourable property of alarming visibility, such labels tend to remain accidentally left on the meat.

What is required is a useful label which on one hand is not too sophisticated, as this would render the product too expensive (like labels bearing an adhesive coating), and which, on the other hand, is characterised by an adequate balance between properly sticking to the meat and, in general, to the food product and ease of removal.

### GENERAL DESCRIPTION OF THE INVENTION

A solution to these requirements was surprisingly found during the development of a collagen label intended to replace the cardboard labels currently used in the stuffing area of a meat processing plant. Special collagen labels were prepared which had a pH value of 5,8 and a swelling rate of 190% and which, on their reverse side, were not coated with an adhesive because the function of sticking was not required. The labels to be developed were only meant to be edible and to be placed on top of the mobile containers loaded with meat emulsion, thus assuring the unambiguous identification of the contents of each container.

The enterprise addressed above also disposes of a “fresh meat department” (slaughter and cutting). As the labels under development were available in the stuffing area of the plant, they were also tested with respect to their potential use for labelling carcasses, halves, quarters and cuts in the fresh meat area of the company. Unexpectedly, it was found that the labels stick perfectly to the meat without being coated with an adhesive and, some days later, can be removed easily and intact from the piece of meat labelled. This was verified various times on different pieces of meat and on meat coming from different species (beef and pork).

In the course of the subsequent studies various labels were manufactured, differing with respect to their pH value and their swelling rates. It was observed that labels with a pH value between 5,5 and 10,0, preferably between 5,5 and 8,5, and a swelling rate between 120% and 450%, preferably between 120% and 270%, most preferably between 180% and 250% show an excellent balance between meat adherence and ease of removal of the intact label from the meat. It is this balance which makes such labels particularly suitable for use in practice.

Swelling rates lower than 120% led to insufficient adherence of the labels while swelling rates higher than 450% resulted in products difficult to print by thermo transfer printing (the most frequently applied technique in the art) and difficult to remove intact from the meat. The most adequate range of swelling rates was found to be, as mentioned above, between 180% and 250%.

The pH range between 5,5 and 10 turned out to be particularly suitable, because within that pH range the crosslinking of collagen, necessary to adjust the swelling rates between the favourable range between 180% and 250%, can easily be achieved either by means of a thermal treatment or by applying low concentrations of crosslinking agents known in the art. This pH range avoids some disadvantages related with strongly acidic and strongly basic pH values: at low pH collagen swells dramatically (with a maximum between pH=2 and pH=3, [3]). Therefore it is difficult to achieve swelling rates as low as the most favourable range of 180% and 250%. This problem is aggravated by the fact that at low pH values most of the side chain amino groups of the collagen are protonated and, therefore, not available as the binding sites for crosslinking agents. On the other hand, at basic pH values >10.0, the collagen starts to swell again dramatically [3], with the disadvantage mentioned before.

### DETAILED DESCRIPTION OF THE INVENTION

The first aspect of the invention relates therefore to removable edible labels based on collagen for labelling food products. By food products, solid food products are meant. Examples of solid food products are: meat products, poultry products or cheese products. Meat products and poultry products are preferred. The removable labels of the present invention are free of any adhesive layer, able to stick to the meat or poultry product throughout the slaughter process until packaging and able to be removed intact from the food product whenever desired. The labels of the present invention are characterised in that they have a swelling rate in water between 120% and 450%, preferably between 120% and 270%, and most preferably between 180% and 250%; and a pH value between 5,5 and 10,0, preferably between 5,5 and 8,5.

The removable edible labels of the present invention preferably present collagen as the main component in weight. However, other additional components can be present in a quantity smaller than that of the main component. Preferred additional components that can be present in the labels of the invention are any of the substances subsequently listed, or a mixture thereof: polyols, cellulose fibres, hydrocolloids, non-collagenous proteins and food approved dyes. (The % next given are based on the weight of the label)

Polyols can be present in the labels of the invention in the range of 0% to 30%, preferably 0% to 15%. Preferred polyols are glycerine, sorbitol, 1,2-propylen glycol and 1,3-butylen glycol. The most preferred polyol is glycerine.

The content of the cellulose fibres in the labels of the invention can be in the range of 0% to 25%, preferably of 3% to 20%.

The hydrocolloid content of the labels of the invention can be in the range of 0% to 45%, preferably of 5% to 20%. Although other hydrocolloids are not discarded, preferred hydrocolloids are any of the substances subsequently listed, or a mixture thereof: modified celluloses, alginic acid, alginates, carrageenan, xanthan gum, locust bean gum, pectin, guar gum, arabic gum, tragacant gum and tara gum.

The non-collagenous protein content of the labels of the invention can be in the range of 0% to 45%, preferably of 0% to 20%. Although other non-collagenous proteins are not discarded, preferred non-collagenous proteins are any of the substances subsequently listed, or a mixture thereof: gelatine, soy protein, gluten, casein and zein.

The concentration of the food approved dyes in the labels of the invention is selected so that that the intended colour shade of the labels is met In general their concentration is in the range of 0% to 10% based on collagen. Although other food approved dyes are not discarded, preferred food approved dyes are any of the substances subsequently listed, or a mixture thereof: titanium dioxide, iron oxides (red, yellow, black), carmine, annatto, Red 3, Red 40, sunset yellow, caramel and carbon black. The most preferred food approved dye is titanium dioxide, which is preferably present in the labels of the invention in the range of 1% to 10% based on collagen.

Although other dimensions are not discarded, preferred dimensions of the removable edible labels of the invention are: width between 10 mm and 200 mm, and wall thickness between 25 μm and 200 μm, preferably between 40 μm and 80 μm.

The removable edible labels of the invention can present on their surface the following motifs subsequently listed, or a mixture thereof: written information, drawings, graphics and painting. These motifs can be either hand made or printed on the label. A combination of both techniques is also possible. The hand made motifs can be written on the label by means of a suitable hand-held pen. The printed motifs can be printed with thermo transfer printer, ink jet printer or laser printer. An edible ink complying with food regulations can be employed therefor.

A second aspect of the invention relates to edible films based on collagen characterised in that said films have a swelling rate in water between 120% and 450%, preferably between 120% and 270%, and most preferably between 180% and 250%; and a pH value between 5,5 and 10,0, preferably between 5,5 and 8,5.

Similarly to the removable edible labels defined in the first aspect of the invention, the edible films of the present invention preferably present collagen as the main component in weight. However, other additional components can be present in a quantity smaller than that of the main component. Preferred additional components that can be present in the films of the present invention are any of the substances subsequently listed, or a mixture thereof,: polyols, cellulose fibres, hydrocolloids, non-collagenous proteins and food approved dyes. (The % next given are based on the weight of the film).

Polyols can be present in the labels of the invention in the range of 0% to 30%, preferably 0% to 15%. Preferred polyols are glycerine, sorbitol, 1,2-propylen glycol and 1,3-butylen glycol. The most preferred polyol is glycerine.

The content of the cellulose fibres in the films of the invention can be in the range of 0% to 25%, preferably of 3% to 20%.

The hydrocolloid content of the films of the invention can be in the range of 0% to 45%, preferably of 5% to 20%. Although other hydrocolloids are not discarded, preferred hydrocolloids are any of the substances subsequently listed, or a mixture thereof: modified celluloses, alginic acid, alginates, carrageenan, xanthan gum, locust bean gum, pectin, guar gum, arabic gum, tragacant gum and tara gum.

The non-collagenous protein content of the films of the invention can be in the range of 0% to 45%, preferably of 0% to 20%. Although other non-collagenous proteins are not discarded, preferred non-collagenous proteins are any of the substances subsequently listed or a mixture thereof: gelatine, soy protein, gluten, casein and zein.

The concentration of the food approved dyes in the films of the invention is selected so that that the intended colour shade of the labels is met In general their concentration is in the range of 0% to 10% based on collagen. Although other food approved dyes are not discarded, preferred food approved dyes are any of the substances subsequently listed, or a mixture thereof: titanium dioxide, iron oxides (red, yellow, black), carmine, annatto, Red 3, Red 40, sunset yellow, caramel and carbon black. The most preferred food approved dye is titanium dioxide, which is preferably present in the films of the invention in the range of 1% to 10% based on collagen.

Although other dimensions are not discarded, preferred dimensions of the films of the invention are: width between 10 and 200 mm, and wall thickness between 25 μm and 200 μm, preferably between 40 μm and 80 μm.

The films of the invention can present on their surface the following motifs subsequently listed, or a mixture thereof: written information, drawings, graphics and painting. These motifs can be either hand made or printed on the film. A combination of both techniques is also possible. The hand made motifs can be written on the film by means of a suitable hand-held pen. The printed motifs can be printed with thermo transfer printer, ink jet printer or laser printer. An edible ink complying with food regulations can be employed therefor.

A third aspect of the invention relates to a process for preparing the edible film of the second aspect of the invention. This process starts from a collagen gel having a suitable composition and is characterised in that the collagen gel is extruded into a tubular or flat film, said film being cross-linked according to any method known in the art, so that the swelling rate in water of the film is between 120 and 450%, preferably between 120% and 270%, and most preferably between 180% and 250%; and that the pH of the film is controlled according to any method known in the art, so that it shows a value between 5,5 and 10,0, preferably between 5,5 and 8,5. This process is next disclosed in detail.

Preferably, an edible collagen casing is manufactured starting with the preparation of a suitable collagen gel, extruding said gel into a tubing by means of an extrusion head with an annular orifice, inflating the resulting tubing through a separate nozzle in the extrusion head with air to prevent the tubing from collapsing and neutralising the tubing formed by means of gaseous ammonia or by the application of an aqueous solution of sodium bicarbonate or sodium carbonate. The tubing obtained is conveyed through a tunnel dryer at the end of which it is flattened between two nip rollers and, finally, reeled.

Details of the manufacture of such tubular collagen casing are known in the art and will not be specified here in all detail. Some details are disclosed in the explanatory example 1, which, however, is related with the manufacture of only one specific casing sample.

Still, for the sake of a better understanding, some additional comments are made below:

The composition of the collagen gel may vary according to the comments made under “I. Definitions”, depending on the intended final composition of the label. The composition of the label, in turn, will determine the characteristics of the collagen gel. For example, to manufacture coloured labels, the colour components are preferably introduced into the collagen gel to avoid later on-line dying steps or off-line dying operations like printing. Pigment colours like titanium dioxide or iron oxide pigments (available in black, brown, red, yellow) or mixtures of these components are the preferred colour additives, because they do not dissolve in water and do not migrate into the meat. However, other food approved colour additives may be applied. Colour is not an essential feature of the labels according to the present invention. However, in most cases coloured labels will be preferred to translucent ones as translucent products are more difficult to localise on the meat and, therefore, tend to accidentally remain on the meat when they should be removed. The colour particularly preferred is white.

The calibre of the casing may be adjusted to the future label dimensions by selecting an extrusion head with an annular orifice having the appropriate diameter. In practice, the calibre range may vary between 10 mm and 200 mm, but it is not limited to this range.

The pH value of the casing may be adjusted by “neutralising” the tubing formed in the extrusion head with different quantities of gaseous ammonia or by varying the intensity of an alkaline treatment (showering with aqueous solution of sodium bicarbonate or sodium carbonate) of the casing tube in the production line.

After reeling, a thermal treatment may be applied to the casing tube obtained in the extrusion process. Typical temperatures applied in the art vary from 40° C. to 110° C., the duration of such treatments are generally in the range between only a few hours and various days.

By means of such a thermal treatment the degree of crosslinking of the collagen may be modified and adjusted to meet the requirements of the final product. The degree of crosslinking is reflected by the swelling rate of the resulting casing and strongly affects the mechanical and hydrothermal properties of the product.

The flattened edible collagen casing is next cut at its edges by means of two suitable knives, thus resulting in two flat films. This operation may be carried out off-line in a separate working step or on-line, immediately after flattening the casing tube by means of nip rollers. In the latter case, the thermal treatment normally applied to the intact casing tube in standard casing manufacture is replaced by a thermal treatment of the flat films obtained after the cutting operation.

Flat films may also be obtained by extruding a suitable collagen gel through a flat nozzle onto a conveyor belt which is guided through a tunnel dryer at the end of which the solidified collagen film is reeled. The manufacture of flat films by this technology is also known in the art and disclosed, e.g., in DE-PS 642 922.

As the flat films manufactured according to either of the technologies explained above serve as the basic materials for the intended removable edible labels, they must be tailored according to the needs of the customer. This statement refers to their width, their colour, their wall thickness and their composition, but also to their compatibility with the printer system to be used in future. For example, in case of using a thermo transfer or a laser printer, a minimum hydrothermal stability of the label is required to avoid distortion of prints like bar codes due to shrinkage of the collagen label. Hydrothermal stability may be transmitted to the collagen by means of thermal treatments, by the use of chemical crosslinking agents or by other crosslinking techniques known in the art or described, e.g., in [1].

Finally, the tailor-made films are reeled to the desired film length.

A fourth aspect of the invention relates to a process for preparing the removable edible labels of the invention. This process comprises cutting the edible film of the second aspect of the invention with a suitable apparatus. Said process can also include a step by which motifs such as written information, drawings, graphics, painting or a mixture thereof are hand made or printed on the label. This process is next disclosed in detail.

A reel obtained as disclosed above can be cut with a cutter device or, preferably, it can be introduced into a printer equipped with a cutting device in order to cut the film into slips with the length of the individual label (the width of the label is defined by the width of the film). The cutter device can be any cutter device known in the art. The printer is a common label printer, e.g. a thermo transfer printer, ink jet or laser printer. The printer ink used should be an ink complying with food regulations. The type of printer may be selected according to cost considerations, the availability of edible inks and the best compatibility with the film material. For example, the impact of film humidity on the performance of the film in the printer/cutting device is demonstrated in example 2. The hand made motifs can be written on the label by means of a suitable hand-held pen.

Use of the Labels in the Slaughter and Cutting Area of a Meat Plant:

The labels generated by the printer are used to label carcasses, halves, quarters and smaller cuts of meat under typical conditions found in meat processing (see example 3).

As already mentioned above, surprisingly, sample labels with a swelling rate in water between 120% and 450%, preferably 120% and 270%, and most preferably between 180% and 250%; and a pH value between 5,5 and 10,0, preferably between 5,5 and 8,5 turn out to show an adequate balance between meat adherence and ease of removal of the intact label from the meat without being coated with an adhesive. Outside this preferred range of parameters sample labels generally fail either due to insufficient adherence to the meat or they adhere so well that they are difficult to remove. In industrial practice, neither of the two behaviours is desired.

In case some hand-written information has to be added to the information provided by the printer, such information may be written on the label by means of a suitable hand-held pen providing an edible ink which is compatible with the food regulations.

If, in the preparation of a meat emulsion for sausages, one of the labels is inadvertently left on a piece of meat and processed along with the meat, the label is comminuted in the cutter, yielding small particles of an edible proteinic product which, in many cases, will not even be identified in the final product by the consumer, because the texture of those particles, due to their ability to take up water from the meat emulsion and swell, will not differ dramatically from the texture of the bulk emulsion. In addition and more importantly, from a standpoint of food hygiene, food regulations and food safety the remnants of the label do not represent foreign bodies in the final sausage like metal, plastic, cardboard or paper would do.

Use of the Labels in the Stuffing Area of a Meat Plant:

In an other application, the label is used to identify different mobile containers filled with meat emulsion for sausage manufacture. Again, if inadvertently one of the labels is stuffed along with the emulsion, the label does not represent a source of food hazard because, in principle, it is edible.

The main application suggested for the labels described above is their use mainly in meat processing. However, their use need not be limited to this field. There may be other fields of application in other branches of food industry, e.g. cheese manufacture or smoked fish.

### EXAMPLES

The following examples are provided to illustrate the invention in yet more detail. They are intended only as exemplary and explanatory.

### Example 1

Manufacture of a White Edible Flat Film Suitable to be Processed into Labels

A collagen gel based on bovine hide splits is prepared according to standard manufacturing conditions known in the art. The composition of the resulting gel is as follows:

| | |
|---|---|
| water: | 3420 kg |
| collagen: | 400 kg |
| glycerine: | 120 kg |
| cellulose powder: | 30 kg |
| TiO₂: | 28 kg |
| Glyoxal: | 1.3 kg |

The pH of the gel is adjusted to pH=2,8 by means of hydrochloric acid.

The gel thus obtained is then extruded through an extrusion head with an annular orifice to form a straight endless tubing. To prevent the tube from collapsing it is inflated with air which is introduced through a nozzle in the mouth part of the extruder. The inflated tubing so obtained is then conveyed through the production line. In a first zone of the line it passes through a tunnel dryer in which the structure of the tubing gets stabilised due to evaporation of water.

When the water content has dropped to about 20% the inflated casing tube is conveyed through a shower section in which it is showered with an aqueous solution of sodium bicarbonate and glycerine. After leaving this section of the production line, the collagen tube passes through a second tunnel dryer at the end of which it is flattened between nip rollers. The flat width of the casing is 122 mm. Before reaching the reeling station the flat tubing is cut at both sides to result in two flat films with a width of 100 mm which are reeled. Finally, the reels obtained are thermally treated at 63° C. for 22 h. Before the thermal treatment is applied, the reels are wrapped with a plastic foil to prevent them from drying out.

The swelling rate of the film obtained is 190%. Its composition is found to be as follows:

| | |
|---|---|
| collagen: | 64% |
| water: | 13% |
| glycerine: | 12% |
| cellulose: | 4.8% |
| TiO₂: | 4.5% |
| salts (mainly sodium chloride): | 1.7% |

The pH value of the film is 5,8. Its basis weight is 850 mg/100 cm² which corresponds to a mean wall thickness of 62 μm.

### Example 2

Printing of the Flat Film and Formation of Labels

4 sample reels of the flat film obtained in example 1 are prepared, each of them containing 50 m of film. The films are humidified to different humidity levels and then introduced into a thermo transfer printer equipped with a cutting device (Apollo 3/200 of “cab Produkttechnik GmbH”, Karlsruhe, Germany). The printer is programmed to generate labels with the dimensions 10 cm×10 cm. The print consists of both bar code and text in clear. The film is fed through the printer with a speed of 100 mm/s. The temperature adjustment for the printer head is “position 10”. The thermo transfer foil used is approved for use on labels which are in direct contact with food.

The absolute humidity levels imparted to the sample films correspond to equilibrium humidity levels which a product like the one tested may adopt upon storage under different environmental conditions (relative humidity of the air: low or high). The performance of the samples in the printing operation can be seen in table 1:

TABLE 1
Film performance in printing and cutting depending
on film humidity

| Sample | Abs. film humidity (%) | Performance in printing and cutting |
|---|---|---|
| A | 5,4 (“very dry”) | Reduced boldness of the print |
| B | 12,3 (“normal”) | No problems observed |
| C | 15,9 (“normal”) | No problems observed |
| D | 19,4 (“moist”) | Film sticks occasionally to the |
| | | rubber roller next to the cutting |
| | | device in the printer → no label |
| | | released |

The shrinkage temperature of collagen is known to be a function of the moisture content of the sample [2]. However, none of the samples tested fails due to deformation by shrinkage of the collagen caused by the heat transfer from the printer head to the label. Still, at “extreme” levels of moisture, observations are made which point to the fact that, in order to obtain best results, the moisture content of the collagen film should be within a “suitable” range, which will depend on the printer type used. For example, in the case of the printer system testet, using the sample labels with the lowest moisture content (sample A), the boldness of the print is reduced as compared to that of the prints on the other labels. At the other end of the humidity range tested, the high moisture sample D fails for sticking to the rubber coated transport roller next to the cutting device integrated into the printer.

### Example 3

Use of the Labels in a Meat Processing Plant.

In the course of the subsequently described operations, labels are used which are generated from the film prepared in example 1.

At the end of the slaughter line, two sides of beef arrive at the weighing point for weighing and classification. Eight labels are generated according to the conditions “B”, using a thermo transfer printer as described in example 2. The labels are printed with a EAN-type barcode and some text in clear. Thus the labels containing all information related with the date of slaughter, identification of the former bull, its weight and its classification and the operators involved. Four of these labels are stuck onto each of the two sides of beef which are then transported to the cold store to lower the temperature of the carcasses.

After 3 days the sides of beef are cut into hindquarter and forequarter in the cool store and then transported to the cutting hall. When the quarters arrive in the cutting hall, the labels attached three days ago still stick perfectly to the meat and have not fallen apart in the course of the storage, cutting and transport actions. The bar code of each arriving quarter is scanned by means of a scanner. Automatically, additional labels are generated and attached to the individual cuts prepared (topside, silverside, thick flank, flank, sirloin and forerib). The trimmings are collected in a box and will later be used to prepare a meat emulsion for sausage manufacture. One of the labels generated before is added to the trimmings in the box. The labelled cuts are then vacuum packed and stored at +1° C. for maturation.

After 2 weeks some of the vacuumized cuts are removed from the cold store. According to visual inspection, the labels have not changed their appearance. No problems are observed when scanning the bar code. As a consequence, the cuts can be traced back to the original animal.

For further processing of the cuts, the labels are easily removed from the meat without causing disintegration of the labels.

In the course of all of the operations outlined above, the labels fulfill all the requirements labels should fulfill in meat processing: A printer directly connected to the EDP network of the enterprise can be used to generate the labels. The labels stick reliably to the meat under all conditions observed and they can easily be removed without disintegration when they are no longer needed. They also remain intact when being vacuum packed with meat and the barcode remains legible.

### Example 4

Use of the Labels in the Stuffing Area of a Meat Processing Plant

In the stuffing area of a meat processing plant labels generated from the film prepared in example 1 and printed according to the conditions “C” of example 2 are tested for replacement of the cardboard labels normally applied to identify different batches of meat emulsion. The test labels bear information both in form of a EAN-type barcode and text in clear. Their size is 10 cm×10 cm. When printing and using the test labels, the operators observe no disadvantages as compared to the cardboard labels commonly applied. They would like to make general use of the labels as soon as they are commercially available.

### Example 5

To compare the adhesion forces to the meat of labels according to the invention and not according to the invention we proceeded as follows:

The first label used was the label according to the invention (LAI) which was based on the film produced according to the example 1. The second label, serving as a model for a label of the prior art (PAL), was manufactured according to basically the same technology, but parameters were chosen such that the label was characterised by the following data:

| | |
|---|---|
| collagen: | 68% |
| water: | 13% |
| glycerine: | 13% |
| cellulose: | 5.4% |
| salts (mainly sodium chloride): | 0.6% |

The swelling rate of the label was 480%, its pH value was 2,9. The basis weight of the PAL was found to be 890 mg/100 cm2 which corresponded to a mean wall thickness of 66 μm.

Both kind of labels were prepared with a size of 10 cm×5 cm. The meat was cut into slices with an area of about 20 cm×10 cm and a thickness of about 3 cm. One lable each was stuck on one piece of meat. Then a metal roller with a weight of 33,6 N was passed over the label from one end to the other and back to the starting point to insure intimate contact. One end of the label was doubled back on itself to form a 2 cm wide flap which would later serve as the flap for the clamp of an Instron tensile testing machine.

The piece of meat and the label so prepared were then put on top of a flat metal plate which was inse

TABLE 2
Adhesion forces of different meat
labels

| | | | Bovine | | Bovine | |
|---|---|---|---|---|---|---|
| | Bovine neck | Adhesion | neck | Adhesion | neck | Adhesion |
| Trial No. | <5 min | Force/N | 30 min | Force/N | 6 days | Forc/N |
| 1 | LAI 1 | 0,8 | LAI 1 | 1,1 | LAI 1 | 1,0 |
| 2 | LAI 2 | 0,6 | LAI 2 | 0,9 | LAI 2 | 1,4 |
| 3 | LAI 3 | 1,3 | LAI 3 | 1,3 | LAI 3 | 2,3 |
| | LAI mean | 0,9 | LAI mean | 1,1 | LAI mean | 1,6 |
| 4 | PAL 1 | 6,1 | PAL 1 | 6,0 | PAL 1 | 7,5 |
| 5 | PAL 2 | 2,5 | PAL 2 | 4,0 | PAL 2 | 7,8 |
| 6 | PAL 3 | 11,0 | PAL 3 | 4,2 | PAL 3 | 4,5 |
| | PAL mean | 6,5 | PAL mean | 4,7 | PAL mean | 6,6 |
| | | | Bovine | | Bovine | |
| | Bovine top round | Adhesion | top round | Adhesion | top round | Adh si n |
| Trial No. | <5 min | Force/N | 30 min | Force/N | 6 days | Forc/N |
| 7 | LAI 1 | 0,5 | LAI 1 | 0,5 | LAI 1 | 2,0 |
| 8 | LAI 2 | 0,4 | LAI 2 | 0,6 | LAI 2 | 3,8 |
| 9 | LAI 3 | 0,5 | LAI 3 | 0,5 | LAI 3 | 1,3 |
| | LAI mean | 0,5 | LAI mean | 0,5 | LAI mean | 2,4 |
| 10 | PAL 1 | 1,3 | PAL 1 | 1,3 | PAL 1 | 22,9 |
| 11 | PAL 2 | 1,4 | PAL 2 | 0,9 | PAL 2 | 4,1 |
| 12 | PAL 3 | 0,6 | PAL 3 | 1,1 | PAL 3 | 2,9 |
| | PAL mean | 1,1 | PAL mean | 1,1 | PAL mean | 10,0 |

LAI = Label according to the invention
PAL = Prior art label

As showed in the examples summarised in table 2, the values of the adhesion forces varied dramatically between the labels according to the present invention (LAI) and those belonging to the prior art (PAL).

Bibliography:

[1] a) K. S. Weadock, E. J. Miller, E. L. Keuffel, M. G. Dunn, J. Biomed. Mat. Res. 32 (1996), 221-226.

b) K. Weadock, R. M. Olson, F. H. Silver, Biomat., Med. Dev., Art. Org., 11 (4), (1983-84), 293-318.

[2] M. Komanowsky, JALCA 86 (1991), 269-280.

[3] a) E. R. Myers, C. G. Armstrong, V. C. Mow, in Connective Tissue Matrix, D. W. L. Hukins, Ed., Verag Chemie, Weinheim, 1984, p. 167.

b) E. Heidemann, Fundamentals of Leather Manufacturing, Eduard Roether K G, Darmstadt, 1993, p. 195.

1. Removable edible label based on collagen for labelling food products, the label being free of any adhesive layer, being able to stick to the food product throughout the slaughter process until packaging and being able to be removed intact from the food product whenever desired, characterised in that said label has a swelling rate in water between 120% and 450% and a pH value between 5,5 and 10,0.

2. Removable edible label according to claim 1 for labelling meat products and poultry products, the label being free of any adhesive layer, being able to stick to the meat product throughout the slaughter process until packaging and being able to be removed intact from the meat or poultry product whenever desired.

3. Removable edible label according to claim 1, wherein the swelling rate in water is between 120% and 270%, preferably between 180% and 250%.

4. Removable edible label according to claim 1, characterised in that its pH is between 5,5 and 8,5.

5. Removable edible label according to claim 1, characterised in that its main component based on weight is collagen.

6. Removable edible label according to claim 1, comprising, in a quantity smaller than that of the main component, at least one component of the following product groups: polyols, cellulose, hydrocolloids, non-collagenous proteins, food approved dyes.

7. Removable edible label according to claim 6, wherein the polyol is glycerine.

8. Removable edible label according to claim 6, wherein the polyol content is in the range of 0% to 30%, preferably in the range of 0% to 15%.

9. Removable edible label according to claim 6, having a content of cellulose fibres between 0% and 25%, preferably of 3% to 20%.

10. Removable edible label according to claim 6, wherein the hydrocolloid is any of the substances subsequently listed or a mixture thereof: modified celluloses, alginic acid, alginates, carrageenan, xanthan gum, locust bean gum, pectin, guar gum, arabic gum, tragacant gum, tara gum.

11. Removable label according to claim 10 having a hydrocolloid content of 0% to 45%, preferably of 5% to 20%.

12. Removable edible label according to claim 6, wherein the non-collagenous proteins is any of the substances subsequently listed or a mixture thereof: gelatine, soy protein, gluten, casein, zein.

13. Removable edible label according to claim 12, having a content of non-collagenous protein of 0% to 45%, preferably of 0% to 20%.

14. Removable edible label according to claim 6, wherein the food approved dyes are any of the dyes subsequently listed or a mixture thereof: titanium dioxide, iron oxides (red, yellow, black), carmine, annatto, Red 3, Red 40, sunset yellow, caramel and carbon black.

15. Removable edible label according to claim 14, containing food approved dyes in the range of 0% to 10% based on collagen.

16. Removable edible label according to claim 1, having a width between 10 mm and 200 mm, preferably.

17. Removable edible label according to claim 1, having a wall thickness between 25 μm and 200 μm, preferably between 40 μm and 80 μm.

18. Removable edible label according to claim 1, having any of the following motifs subsequently listed or a mixture thereof: written information, drawings, graphics and painting, wherein the motifs have been either hand-written or printed by means such as thermo transfer printer, ink jet printer or laser printer.

19. Removable edible label according to claim 18, wherein at least an edible ink is employed.

20. Edible film based on collagen, characterised in that said film has a swelling rate in water between 120% and 450% and a pH value between 5,5 and 10,0.

21. Edible film according to claim 20, wherein the swelling rate in water is between 120% and 270%, preferably between 180% and 250%.

22. Edible film according to claim 20, characterised in that its main component based on weight is collagen.

23. Edible film presenting the composition and characteristics of claim 1.

24. Process for preparing an edible film according to claim 20 from an appropriate collagen gel, characterised in that the collagen gel is extruded into a tubular or flat film, said film being cross-linked according to any method known in the art, so that the swelling rate in water of the film is between 120 and 450%, and that the pH of the film is controlled according to any method known in the art, so that it shows a value between 5,5 and 10,0.

25. Process for preparing the removal edible labels defined in claim 1, characterised in that the appropriate edible film according to claim 20 is cut.

26. Use of the edible films according to claim 20 for the preparation of the removable labels of claim 1.

27. Process for preparing films according to claim 20 or labels according to claim 1 presenting the motifs according to claims 18, characterised in that these motifs are either hand made or printed by any means such us thermo transfer printer, ink jet printer or laser printer.
